(19) United States
(12) Patent Application Publication
(10) Pub. No.: US 2001/0043237 A1
(43) Pub. Date: Nov. 22, 2001

(54) Method and system for distributing simulated physical objects and systems in a networked environment

(76) Inventor: Robert William Schmieder, Walnut Creek, CA (US)

Correspondence Address: ROBERT WILLIAM SCHMIEDER, 4295 WALNUT BLVD., WALNUT CREEK, CA, 94596, US

(21) Appl. No.: 09/751,583

(22) Filed: Dec. 30, 2000

Related U.S. Application Data
(60) Provisional application No. 60/173,709, filed on Dec. 30, 1999.

(51) Int. Cl. G06F 13/00

(52) U.S. Cl. 345/839; 345/706

(57) ABSTRACT

A method and system for distributing computer simulations in a network environment at zero bandwidth. The system comprises four networked computers: a Generator, Manager, Client, and Server. The Generator creates the simulations in the form of components and assembly instructions. The Manager stores, manages, and distributes the components and instructions, and also references to those simulations on the Server. In operation, the Client requests a document from the Server, examines it for previously known indicators, and triggers the re-assembly of the simulation on the Client using locally stored components. Zero bandwidth results from doing the computer-intensive work at run time entirely on the Client. The invention has the additional advantage of requiring zero modification to the Server.

### BACKGROUND OF THE INVENTION

1. Field of the Invention

The present invention relates to distribution of complex dynamic content, and particularly to distribution of simulations of physical objects or systems with complex interactive behaviors, to clients on a computer network.

2. Description of Related Art

Transfer of 3D images, sound, and other dynamic, interactive media over networks presents formidable challenges. The central limitation is the bandwidth of the network, which determines the amount of data that can be transferred in an acceptable time interval. The presence of rich media typically slows the transfer so much that content is compromised: Often the content is simplified or truncated to enable its transfer, but this can result in poor quality and unacceptable loss of functionality.

Improvements in bandwidth are enabling richer media to be transferred, but even at very high bandwidth, another problem emerges: the necessity to create the content before transferring it. In a typical client-server network, the client is interested in only a small subset of the possible data, but the server does not know in advance which subset. Therefore, the server is required to generate the entire dataset, in order to have that particular subset the client may request. Imagine a relatively simple product with 10 components, each with 10 values, each of which significantly affects the product dynamics. To present this product with streaming media would require more than 100,000,000 audio/video clips, each of perhaps 5 MB, with a total storage of 50 million gigabytes. Such a requirement is patently absurd, and illustrates the severe limitations of generating and serving complex data structures.

Alternatively, the host may attempt to generate the content in response to a request from a client. The problem with this is that the host must install and maintain a complex application capable of responding to requests, generating the content as media, and streaming it to the client. This effort will nearly always be well beyond the capability or interest of the host.

Compression is one means of reducing bandwidth demand. Static file compression schemes typically are capable of reducing file size to ⅓ (1/10 in special cases). The most effective compression schemes are content-dependent, and derive advantage from redundancy, predictability, and emptiness of the dataset. However, even powerful content-dependent compression schemes such as MPEG-4 cannot come close to satisfying the demand for rich media over networks.

The limitations of networks are particularly important in e-commerce conducted on the internet. Manufacturers and resellers want to present their products on the web as realistic, interactive, 3D images that attract, intrigue, and gain the trust of shoppers, and ultimately convert them to buyers. However, no such capability currently exists on the web, primarily due to the inability to deliver the rich media necessary to provide the experience demanded by the shopper.

Recently attempts have been made to provide partial solutions to this problem. One solution is to serve the client a series of images that can be “played” or selected, to give the user a sense of motion, or at least of control. For instance, a series of 20 images of a person, taken at even angular positions, could present the illusion of the person rotating in place. The bandwidth demanded for this procedure is far too high for any practical application, and is of interest only as a transient curiosity.

Another solution that is being used is to combine generic shapes with textures and photographs. For instance, photographs of a coin could be applied to a disk, giving a surprisingly realistic image of a real coin. This has been used in more complex systems: putting a face on a spheroid creates a startlingly good representation of a 3D head. However, this solution requires downloading large bitmap graphic files to the client, hence suffers from high bandwidth demand and low image resolution.

The importance of high-quality simulations of consumer products in e-commerce is now recognized. A recent study by Ernst and Young emphasizes the importance of rich, accessible, informative, intuitive, and customizable content for converting shoppers into buyers. Except for concerns about security, by far the most important reasons for not buying online is that shoppers prefer to see the product, talk with sales representatives, and get more information about the product. Long download times are another major factor in missed selling opportunities. Among the most important factors for buying online are how well the products and their uses are described, and how well the products are pictured.

In spite of rapidly developing technology, a true web shopping capability currently does not exist. What does exist is listings of products, sometimes with small photographs, and tools for facilitating purchases. This is equivalent to catalogs and order forms. The central tenet in advertising is that the customer develops trust and personal identification with the seller and the product, but this is currently unsatisfied. The shopper has no ability to see how the products work, take them for a “test drive,” learn how to install, use, maintain, repair, and dispose of the products, see how they age, to personalize them and combine them with other products, put them in the shopper's personal environment, to try them on, to understand how they work, or (sometimes) understand what they do.

Besides web-based shopping, there are many other related applications that might involve transfer of rich, complex content over a network. Some of these are:

Animated content creation

Assembly instructions, maintenance and repair guides

Biomolecular dynamics and drug design

Business communications

Data visualization

Directions for product disposal

Education and training

Engineering design

Entertainment

Forensic simulation

New product simulation

Product comparison, personalization, alteration

Product use in unusual environments

Scientific simulations

Standards administration and use

Web-based interactive games.

While some of these tasks are done in a non-network environment, all of them will benefit from networking, but only if the content is rich enough and can be shared fast enough to be useful to the users. The present invention makes this possible.

### DEFINITIONS

ExpertShopper™

This invention has been assigned the provisional commercial name ExpertShopper™. In further description of the invention, occasional use will be made of this name, which is taken to be symbolic of the invention, independent of any particular realization of the invention.

Product (=object or system)

A named assembly of components that resembles or functions as a whole for some defined purpose, traditionally as a commercial product, but more generally any object or system.

Component

A named identifiable structure or subset of a product. A component may have behavior independent of product, but may behave differently when incorporated in the product. Components can themselves be assemblies, with many internal degrees of freedom, and behaviors can be treated as components.

Instructions

A single or compound set of statements or algorithms that indicates the relationship of multiple components in a product, and may indicate the sequence of assembling those components into the complete product.

Simulation

The combination of a set of components and set of instructions, which taken together provide the capability to assemble a complete simulated product.

Part

A named piece or subset of a product. Parts typically have no internal moving pieces, are usually not further divisible, and generally would not have behavior of their own of interest to the system. It is generally an identifiable, separately manufactured item that is combined with other parts to form assemblies.

Assembly

A subset of a product that is comprised of more than one part or component. An assembly has a special function, but is itself a subset of the product.

Structure

A particular arrangement of matter, including the appearance and properties of that matter. An environment generally does not have structure.

Behavior

Changes in properties over time. Behavior itself may be assembled from components and parts, which can themselves change in time, producing changes in behavior. An object or system may have multiple behaviors: For example, a bomb behaves as a deadweight before release, as a projectile when dropped, and as an explosion when detonated.

Environment

A set of conditions to which a complete product can be subjected, and which may alter its behavior. An environment generally will act on a product without itself being significantly altered by the interaction, although back-effect is possible. Examples of environments include gravity, wind, light, heat, and humidity.

### BRIEF SUMMARY OF THE INVENTION

The present invention is an integrated method and system for distributing simulated objects or systems (which we will also refer to as “products”) over a network. It comprises the following:

1. A “Generator,” which contains the original definition of the simulated object or system, and means for dissembling it into components and instructions for reassembling the components into the original object or system. The generator can reside anywhere.

2. A “Manager,” which contains the components and assembly instructions for various simulations, and data representing documents on the network that may contain references to the simulations. The manager resides on a controlled server on the network, and distributes these data to one or more Clients on the network.

3. One or more “Clients” that contain a subset of the data on the Manager, in particular a selected subset of components, assembly instructions, and document locations. The Client resides on a computer on the network, and is accessed only across a communications link that restricts the flow of data.

4. One or more “Servers” that store documents that may contain references to the simulations, and that are served to Clients across the communications link when requested.

The system works as follows:

First, the Generator is used to create a simulated object or system (=product), and to separate it into components, and to produce a set of instructions for re-assembling the product from those components. The components and instructions are passed to the Manager, which distributes a subset of them to the Clients.

Second, the user requests a document from one of one of the Servers, and receives the document as a data stream via the network communications link. As the document is being received, the Client searches it for indicators that match a stored list of indicators. A successful match enables the Client to uniquely identify a simulation, that is, a set of components and assembly instructions. The Client then assembles the simulated product, and displays it on the computer monitor.

Once the product identification is made, no further interaction with the network is needed. The Client constructs the simulation, and the user can interact with it to experience a dynamic, interactive simulated product.

The simulation is generally constructed on the paradigm of “assemble and activate,” by which is meant that the mechanical or physical structures are assembled, and then behaviors are added. The simulation process typically, but not necessarily, mimics the actual physical process of assembly and activation of a real product.

The invention as described enables the following central advantages:

Zero bandwidth

Zero server modification.

Zero bandwidth means that the identification of the product and the assembly of the simulations according to instructions are entirely done on the Client computer. No simulation content is passed from the Server to the Client, hence the time required for downloading the document from the Server is unaltered. If the Client does not have some resources required for the simulation, it must request them from the Manager, and because of the limited speed of the communication link, additional time is needed to complete the simulation. However, this time will generally be negligible compared to the document download time, providing effectively zero-bandwidth. In typical operation, the simulated product can be assembled and displayed before the incoming document is complete.

Zero server modification results from the fact that the product is identified from information embedded in the downloaded document that is an intrinsic part of the document itself. This information is known to the Client before the document is requested. When the document is downloaded, the Client searches for known patterns, and triggers the assembly of the simulation when it obtains a match.

Together these features enable the Client to obtain complex product simulations with essentially zero delay and without modifying documents stored on Servers. Thus, it simultaneously solves the problem of limited bandwidth and rich content distribution. Other advantages and uses will be clear from the full description of the invention.

### BRIEF DESCRIPTION OF THE DRAWINGS

These and other objects, features, and advantages of the invention will be more readily apparent by examination of the following drawings, described briefly here:

FIG. 1 is a block diagram of the invention, showing the computers in the network and the flow of information before and after the Client requests a document.

FIG. 2 is a diagram showing an example of the operation of the invention in time, in particular how the invention achieves zero bandwidth.

FIG. 3 is a diagram of the computer screen layout in a preliminary working version of this invention.

FIG. 4 is a diagram of the browser window layout in the preliminary working version of this invention.

FIG. 5 is a diagram of the simulation window in the preliminary working version of this invention.

FIG. 6 is a drawing of a generic component, in this case a computer key. FIG. 6A shows a generic key, and FIG. 6B shows a generic keypad.

### DETAILED DESCRIPTION OF THE INVENTION

### General Description

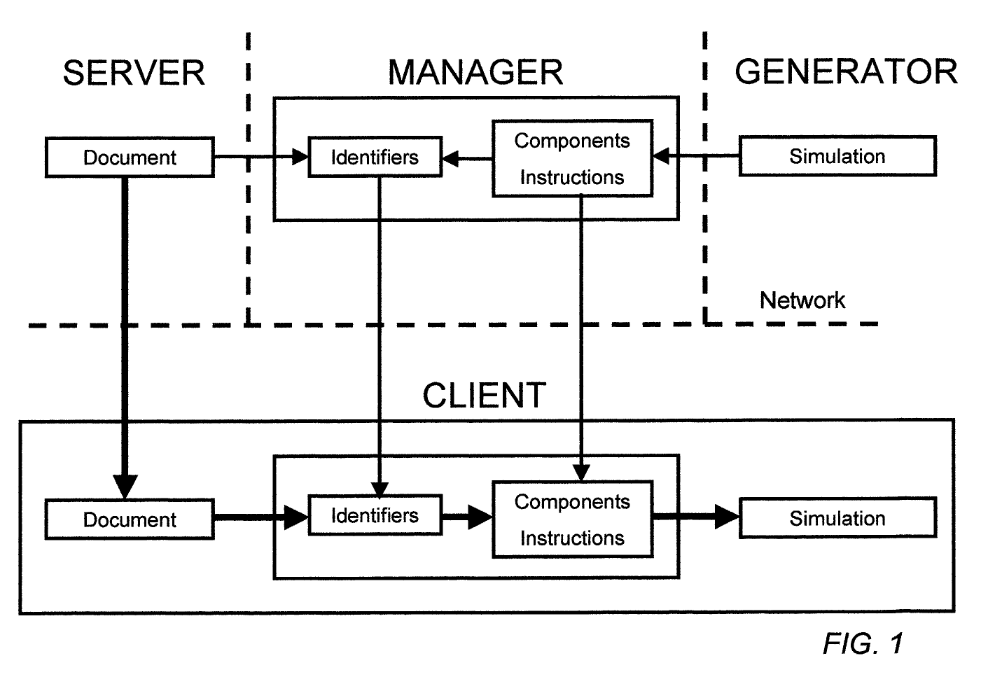

The invention will be described in detail with reference to FIG. 1-FIG. 6. It will be appreciated that this description and these figures are for illustrative purposes only, and are not intended to limit the scope of the invention. In particular, various descriptions and illustrations of the applicability, use, and advantages of the invention are exemplary only, and do not define the scope of the invention. Accordingly, all questions of scope must be resolved only from the claims set forth elsewhere in this disclosure.

FIG. 1 shows the fundamental concept of this invention. The figure is a block diagram representing software modules installed on several computers connected to a network such as the internet, and communicating via a protocol such as HTTP as used on the World Wide Web.

The invention comprises the following parts:

Generator

Manager

Client

Server

The Generator contains means for creating the original software version of a simulation of an object or system, commonly referred to as a “Product.” The Generator may be an authoring application, or it may import the simulation from another application and (possibly) convert it to a desired format. The Generator has means for separating the simulation into two sets of information:

Components

Instructions.

The nature of the components and instructions depends on the nature of the object or system being simulated. Most commonly, it is a physical object or system, and the simulation is a graphic representation that can be displayed on a computer monitor. In this case, the components will be analogs of physical parts of the product, and the instructions will be a sequence of operations necessary to assemble these parts into the product. In most cases, the assembly will correspond closely with the assembly of the physical product, and this analogy is in fact a powerful guide for the definition of the components and instructions.

The instructions also provide the means to enable the product to exhibit behavior. Quite generally, behaviors can also be considered components, and can themselves be assembled by other instructions. For instance, a switch operating a light can be described as two physical components plus a single behavioral component. In this case, part of the instructions (“turn the light on and off with the switch”) are represented as a component (one Boolean variable equal to another Boolean variable). The non-component instructions are used to guide the assembly of the simulation.

Considerable increase in performance is obtained if the components and instructions can be used for more than one product. For instance, if a generic electronic button can be configured for use by many products, the production, distribution, and storage of many (nearly identical) buttons can be avoided. The same advantage obtains for assembly instructions: to the extent that similar assembly procedures can be used for many products, the generation, distribution, and storage requirements are reduced. This invention assumes, but does not require, that the components and instructions are generic to the extent possible.

The Generator passes the components and instructions to a particular computer on the network designated the “Manager.” This computer receives the components and instructions, stores them, manages them within a multi-dimensional database, and performs various operations such as validation, replacing obsolete versions, compression, eliminating unused versions, extracting common features, recasting into hierarchical form with managed commonality, generating statistics and human/machine accessible meta-information, defining priorities for access, generating abridged versions, and establishing associations between members of the dataset.

The Manager responds to requests from Client computers on the network. It can engage in dialogs that provide for: downloading components and instructions to the Client; replacing obsolete modules on the Client; optimizing the allocation of resources such as storage space on the Client; setting priorities for the Client to use the components and instructions; establishing thresholds and protocols for communicating with the Manager; extracting meta-information about the Client hardware; and acquiring use statistics and demographics of Client activity. The purpose of this functionality is to provide the Client computer with the means to generate a simulation of a product, given a unique identification of that product.

The Manager also generates, stores, manages, and distributes information about documents on the network that may contain reference to products. These documents are stored on Server computers connected to the network, and accessed by the Clients via a communications link. Normally, the Client uses a browser such as Netscape or Internet Explorer, which implements a standard protocol such as HTTP, to send a request to a Server, which responds by downloading a copy of the requested document. Some of these documents may contain embedded references to products that can be simulated. These references are typically in the form of images, words, or hidden identifiers. In principle, a reference of any kind could be used as a trigger to assemble and display the simulated product, so long as the reference uniquely identifies the product.

The Manager therefore also carries out the task of defining, acquiring, storing, managing, and distributing references to products found in documents stored on Servers. A given product may be referred to in many documents, and a single document may contain references to many products. In the simple case of a single product shown on a single document, the document itself be used for the identifying reference. Thus, the URL of a document showing a single product image uniquely specifies the product. If however, the document includes one or more images of the product, the URLs for those images also uniquely identify the product.

The Manager must maintain a database of identifiers, and must optimize the data to eliminate redundancy, reduce storage size, and ensure uniqueness. As an example, suppose a document contains an image of a product. This image has a unique URL, which is generally in the form

http://www.host.com/directory/ . . . /directory/image.jpg

The most stable parts of this URL are the name of the host and the name of the image. This is because the host is generally the name of the business showing the product, and because webmasters seldom change the name of graphic files, whereas the directory structure in the host computer is often changed. Therefore, a good identifier would be the binomial:

Product=(“host”,“image”)

The manager generates a database of such pairs by several means: direct examination of the documents by access with a browser; information supplied by the host; and information supplied by an independent service that searches and compiles occurrences of the identifiers.

The Manager distributes the components, instructions, and identifiers to the Clients. However, because of space limitation on the Clients, it must reduce this information. It can do this by any of several means: encoding, compression, selection, hierarchy, and truncation. Encoding exploits the fact that the information exists within a finite world of information, so that it takes less information to identify an element than it takes to define it. Compression exploits redundancy, symmetry, predictability, and emptiness to increase information density. Selection exploits prioritization to reduce membership. Hierarchy transforms relationships between entities into compression. Truncation replaces larger items with smaller ones.

The requirement placed on all these schemes is that they preserve uniqueness: the identifier must uniquely correspond to a set of components and instructions, so that one and only one simulation will result. It is the Manager's task to implement the Client resources in such a manner that they are as small as possible while preserving uniqueness.

In principle, every Client in a network will have a unique combination of resources. It is assumed that the Client can set preferences such as: the total disk storage space allotted to components, the timing of updates from the Manager, whether the simulations will include audio/video, and whether the Client will automatically report use information to the Manager. Some of these preferences may affect the information requested and received by the Client, and therefore the Manager must have the capability to develop a representation of the individual Clients, and to adapt its response to requests from individual Clients.

It is important to note that all the previous steps taken by the Generator, Manager, and Clients are done across a bandwidth-limited communications link. Thus, the generation of simulations and separation of simulations into components and instructions, generation of identifiers, distribution of components, instructions, and identifiers to the Manager and Clients, and most utility or housecleaning operations, can be done at relatively low bandwidth demand, and in advance of the request for a simulation. These steps “prepare” the system for downloading a document, an event that could trigger the generation of a simulation on the Client.

The Servers respond to Client requests, generally by downloading the requested document. Such documents need no modification in this invention, since they already contain sufficient information about the product to uniquely identify it. Therefore, no modification of the server is required. However, in order to inform a Client that the Server may have documents containing information about products that can be simulated, it may be desirable for the Server to make such modification, such as adding a flag or popping up a notice on the document when viewed in the Client browser.

As the requested document begins to arrive at the Client, it is examined. The Client searches for correspondence between the incoming data and the locally stored identifiers. When a match is made, the Client consults a reference list to determine a unique citation of the product. This citation enables the Client to access a list of resources needed for the simulation, including components and instructions. If all the needed resources are available on the Client, the Client proceeds to assemble the simulation from the components, and if the simulation is a graphic it is normally displayed on the Client monitor.

The process of identification of the product and assembly of the corresponding simulation is extremely fast. The assembly normally begins as soon as a single match to a reference identifier is obtained, even though the incoming document is still downloading. Even if the network is very slow, or the download is interrupted completely, the assembly of the simulation proceeds, since it needs nothing else from the Server.

If multiple matches to reference identifiers are made, implying several products to be simulated, the Client caches the matches, and according to preference settings will either display all or part of them, or wait for action by the user. In one version of the Client described in more detail below, a separate window is opened and a thumbnail image of each matched product is generated in the window. The user selects the product to be simulated by selecting a thumbnail.

The net result of all these processes is to transfer the simulation from the Generator to the Client. This occurs in two steps:

1. (Light arrows in FIG. 1) Loading components, instructions, and identifiers on the Client, thereby preparing the Client for a triggering event;

2. (Dark arrows in FIG. 1) Downloading a document from a Server that contains information that matches one or more identifiers, thereby triggering the assembly and display of the simulation.

It is clear that the main advantages of the present invention are attaining high speed in producing the simulation on the Client, and requiring no modification of the Server. These are similar to the advantages realized by the manufacture of an explosive, and the subsequent triggering of the explosion by a nonspecific source. In some sense, “potential energy” is slowly added to the network over a long period, stored, and then released very quickly as “kinetic energy.” The analogy to “conservation of energy” is also appropriate: the initial simulation is disassembled by the Generator and stored as distributed entities. The trigger then causes the lossless re-assembly of these entities into exactly the original simulation.

Reiterating, the present invention achieves its speed advantage by:

1. Restructuring the simulation into generic pieces that can be used for many simulations, thereby reducing the inventory necessary to simulate many products;

2. Restricting the information that must be transported across bandwidth-limited communication links;

3. Putting all the information for a simulation on the Client to take advantage of the extremely high effective internal bandwidth of the computer;

4. Setting the trigger in advance.

The goal of these techniques is to reduce the information that must be moved across the network. The process is technically known as “content-dependent compression,” although it should not be considered a compression technique. Another way to rationalize the advantage is that it uses low-bandwidth over a long time for storage, and high-bandwidth over short time for release.

Regardless of the specific implementation or interpretation, the present invention has the net result of distributing simulations from a Generator to Clients.

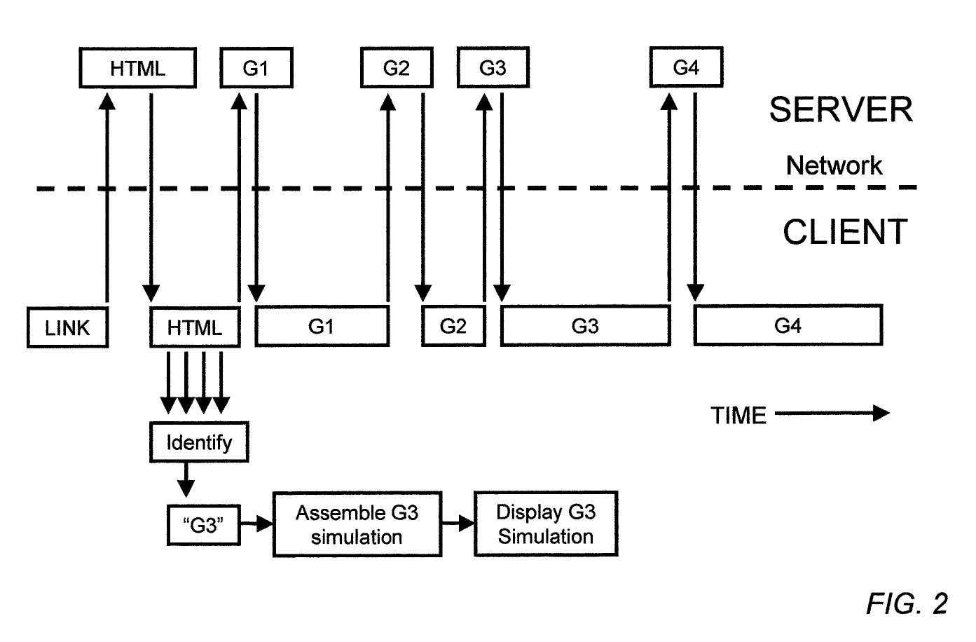

FIG. 2 is a diagram showing an example of the operation of the invention in time, showing how it enables generation of the simulation and display in zero additional bandwidth. In this diagram, time increases from left to right. The dashed line indicates the network; arrows crossing the network line indicate transfer of data across the network connection. The Server is indicated above the network line, and the Client is indicated below that line. It is assumed that the Client is using a browser capable of requesting HTML documents from the Server using HTTP protocol, and that the HTML documents are displayed on the Client computer.

The process begins when the Client requests a document from the Server. The Server begins to download the requested document, which is an ASCII character file in HTML format. Embedded within the HTML may be a series of references to graphics or other resources that are part of the document. The browser is able to examine the entire document, identify embedded elements, and go back to the Server to obtain missing elements. As these elements arrive, the browser incorporates them in the document, optionally displaying the document as it is assembled. The entire process of assembling the document may require many requests, and the arrival of various elements can be irregular, due to the unpredictable state of the network. Complete download of a typical document, such as a web-based store home page, may take many minutes. Furthermore, the download can be interrupted, and the document never completed.

The limitations using this scenario to download rich, interactive content such as product simulations are significantly more sever than for simple documents. Given the long times needed, the likelihood of delay, corruption, interruption, and termination is high. Usually, the time needed to download complex simulations is greater than the Client is willing to devote.

The lower parts of FIG. 2 show how this invention overcomes these limitations. As soon as the HTML document begins to arrive, it is examined by the Client software. The Client has a list of reference patterns, which may be strings of ASCII characters, and it searches for occurrences of these strings in the document. At some time, it finds a match to one of the reference patterns (“G3” in this example), and corresponding to that pattern is a unique identifier for a specific product. The identifier is passed to an executive program that carries out all the steps to assemble the simulation: it checks to see what resources are required; checks to see if all those resources are available locally; obtains any resources that are not available by requesting them from the Manager (not shown in FIG. 2); organizes the assembly task into sequences and assigns responsibilities for subtasks; carries out the actual assembly of the simulation; performs tests to ensure that the simulation is correct; and finally delivers it to the display (or non-displaying consumer).

An important aspect of this invention is that examination of the HTML document begins as soon as it begins to arrive from the Server, rather than waiting for the document to be completed. HTML documents are formatted such that additional resources needed are indicated in headers, or at least early in the document. The present invention makes use of such information as identifiers, and these identifiers can be matched with reference patterns without waiting for the document to be complete. Thus, the process of assembling a simulation is begun almost immediately after the first communication from the Server, and typically will produce the simulation on the display before the HTML document is complete.

As a specific example, FIG. 2 shows an HTML document with four embedded graphics: G1, G2, G3, and G4. The Client contains a reference to G3. As the HTML document arrives, G3 is identified, and this happens long before the browser sends out the request for the G3 graphic. The simulation corresponding to G3 is complete and displayed before the G3 graphic has completely arrived at the Client.

Another important aspect of this invention is that the simulation is independent of the connection to the network, once the identification of the product has been made. Thus, the simulation is generated in a time determined by the internal speed of the Client computer, not the network data transfer rate. Even if the network connection is broken, once the product has been identified, the simulation is successfully generated.

The speed advantage of this invention is compromised if the Client does not have all the required resources. For instance, suppose the simulation requires the inclusion of an audio file, and it is necessary to go to the manager (or other network server) to obtain that file. Since this process adds download time, the “zero bandwidth” character of this invention will be compromised.

Another way the speed advantage of this invention could be compromised is if the assembly of the simulation itself in the Client computer is very complex. If the components and instructions used to assemble the simulation are very small and very numerous, the assembly could take as long as the download of the complete simulation from a server might take. There is obviously an optimum combination of the number of components and the assembly procedure.

Another way the speed advantage of this invention could be compromised is if the HTML document contains many identifiers that match Client-based references, so that many product simulations are requested. Since the assembly of the simulations requires the computer CPU and possible other support functions such as disk access and RAM, the simultaneous of a large number of simulations could slow the performance of the computer to an unacceptable level. The defense against this problem is to establish priorities for generating the simulations, executing them in a sequence that might correspond to the user's needs or preferences.

### Features of the Invention

The most important features of the present invention are: (1) its ability to distribute complex simulations to Clients at essentially zero additional download time; (2) zero modification of the server that triggers the simulations. These capabilities enable this invention to deliver simulations that have high-quality, 3D, virtual-reality, zoomable graphics, including images that are dynamic, interactive, and intuitive. Some additional noteworthy features of this invention are described below.

Viral installation

The present invention requires a software package to be installed on the Client, and normally this would be done in a single step. However, because of the modular nature of the information and user interaction, it is not necessary to install the entire package at once. Rather, the Manager can establish a dialog with the Client to determine the computer configuration and resources, the preferences, and the user's immediate needs. With this information the Manager can provide a modular installation, providing the highest-priority first and lower priority items later. The user may not be aware that the installation is modular.

Triggering simulations by selected Servers

The simulation is assembled upon receipt of a document from a Server that contains a valid and unique identifier of the simulated product. Because the Client maintains a list of these identifiers (with possible extension by the Manager), the Client could, in principle, include identifiers on any particular individual Server, or on a group of Servers, or all Servers everywhere. Thus, a very popular product that is presented on hundreds of Servers could be triggered by all of those Servers by simply updating the list of identifiers on the Client/Manager.

Prevention of triggering by selected Servers

In the same way that the Client/Manager can enable triggering the simulations from any Server, they can also disable triggering from any individual, group, or all Servers. One useful application of this feature would be to disable the simulations if a host fails to fulfill contractual obligations.

Extended capture time

Capture time is the time the user is willing to wait for a request for a document to be processed and the document presented. Web-shopping clients have a notoriously short capture time, less than 10 seconds. The present invention will significantly extend this capture time, so long as the simulation is launched and completed in times very short compared to the document download time. This works because a user will be reluctant to abandon a rich, interactive simulation of the desired product. It is expected that this invention will extend capture times from a few seconds to many minutes.

Zoomable graphics

With the ability to obtain high-quality 3D virtual reality simulations, the user will be able to zoom in on small details, magnifying the product at will. This feature is especially useful for products in which a single or small component is mission-critical. Thus, this invention provides a qualitatively better experience for the user that is generally unobtainable with other methods.

Onscreen expert (avatar)

For certain applications, it may be desirable to include in the simulation an image of a human, or avatar. This avatar can be considered equivalent to a product, in the sense of being a graphic representation with programmed behavior. One important use of such an avatar would be to provide an onscreen “expert” that knows about the product and that can also communicate with the user. Such an expert is widely recognized as being an aid to shoppers, assisting with the principle activity, namely learning about the product and gaining trust.

Personalization

The present invention lends itself naturally to capturing certain information from, or about, the user. For instance, a woman could complete an inventory of body measurements, color schemes, and style preferences, and these could be used on the Client to configure or select such simulations based on such information.

Automatic updates

By design, this invention has the capability to automatically update itself. The process is initiated by the Client, and serviced by the Manager. One possible scenario is the following: At the beginning of each network session, the Client announces itself to the Manager. The Manager and Client then engage in a dialog that may be of the following form:

Client: I am [CLIENT].

Manager: Can you verify that you are [CLIENT]?

Client: Here is my [VERIFICATION].

Manager: What [SERVICES] are you requesting?

Client: Do I need to be updated? Here is my last update [DATE].

Manager: You need updating. Here are your [OPTIONS].

Client: Here are my [SELECTED OPTIONS].

Manager: What are your update [PREFERENCES]?

Client: Here are my [SELECTED PREFERENCES].

Manager: Here are your [UPDATES].

Client: I have received the [UPDATES]. I need additional [RESOURCES].

Manager: Here are the [RESOURCES].

Client: OK

Later in the session, the dialog may be of this nature:

Client: Do you have [INFORMATION] about the following [PRODUCT]?

Manager: I have the following [INFORMATION].

Client: I need the following [SELECTED INFORMATION].

Manager: Here is your [SELECTED INFORMATION].

Client: OK

The Manager may initiate a dialog of the following nature:

Manager: [CLIENT] are you there?

Client: I am [CLIENT]. Can you verify that you are [MANAGER]?

Manager: Here is my [VERIFICATION].

Client: What is your [REQUEST]?

Manager: I have [NEWS] for you.

Client: What [KIND OF NEWS] it is?

Manager: The news is of the following [KIND].

Client: Please [DELIVER] the news, with the following [PREFERENCES].

Manager: Here is your [NEWS].

Client: OK

Dialogs such as these will be automatic and invisible to the user. They are an essential part of this invention, necessary to enable operation, growth, and other services.

Use data

The fact that the Manager and Client work together to enable distribution of the simulations means that they have the capacity to capture meta-data and use-data. For example, the once the simulation is displayed, the user will most likely interact with it for an extended period, and it is relatively easy to capture these interactions in a log file. This file could be kept locally on the Client, perhaps to enhance performance by setting priorities. Alternatively, they could be processed and transferred to the Manager. Information about the user's interaction with the simulations will be of great value in designing other simulations, and it could be used by the supplier of the product to learn about the habits of potential buyers. While this aspect presents a powerful tool, ethical considerations will have to be included in any contemplated implementation.

Hardware acceleration

We anticipate that hardware accelerators will be useful for increasing the performance of the present invention. An accelerator could be used in several ways: (1) to increase available complexity by pre-computing numerical approximations to complex dynamic functions; (2) to increase rendering speed for complex virtual products; (3) to decrease assembly time by handling complex transforms needed for system constraints. Currently, most graphics accelerators in desktop computers implement OpenGL or DirectX graphics. Experience shows that a graphics accelerator with at least 8 MB of RAM is practically essential for reasonable performance of typical simulations.

### Operation of the Invention in Practice

In this section we present a description of exemplary operation of the invention. It should be understood that this operation does not define or limit the invention. Rather, it is a general description of how particular embodiments of the invention might operate.

ExpertShopper™ Alpha

An operating version of the system and method of this invention was created, and has been used for commercial purposes. The package was implemented in VRML, JavaScript, Java, and HTML. The software exists as the following modules:

| Module | Files | Purpose |
|---|---|---|
| index.html | 1 file, 1.6 kB | Launch file for the application |
| /Pages | 48 files, 392 kB | HTML pages for the client interface |
| /JavaScripts | 39 files, 126 kB | Scripts to enable the interface |
| | | dynamics |
| /CosmoDoc | 49 files, 329 kB | Documentation for CosmoPlayer. |
| /Images | 280 files, 2.6 MB | .gif and .jpg images |
| /Instructions | 6 files, 8.0 MB | Help and tutorials |
| /JavaClasses | 5 files, 163 kB | EAI Java scripts for toolbar |
| /Online | 117 files, 1.35 MB | The simulated online store |
| /Sounds | 16 files, 4.1 MB | .wav files |
| /Library | 116 files, 17.7 MB | VRML simulations |

The package operates entirely from within a standard browser, either Netscape or Internet Explorer. The application is started by loading the page index.html into the browser. This page provides access to the web via direct links to stores offering a total of about 20 products. Each product is simulated by a VRML file that is stored in the Client computer. Thus, this version uses 1-component products.

As each page is accessed via the web, the software examines it for embedded graphic image URLs that match any entry in a list of about 500 ASCII strings. The search is paced by a pulse trigger generated by a JavaScript script that creates a logical event about once per second. In order to reduce the search time, duplicate URLs and obvious exceptions are eliminated before comparison. As soon as a match is made, the software determines the unique product name from a list. This name is then used to locate the VRML file, and loads it into a new window containing a clone of the browser. In typical operation with real websites, the package takes about 3 seconds to identify the product and display the simulation. Once displayed, the simulation is persistent across web disconnect.

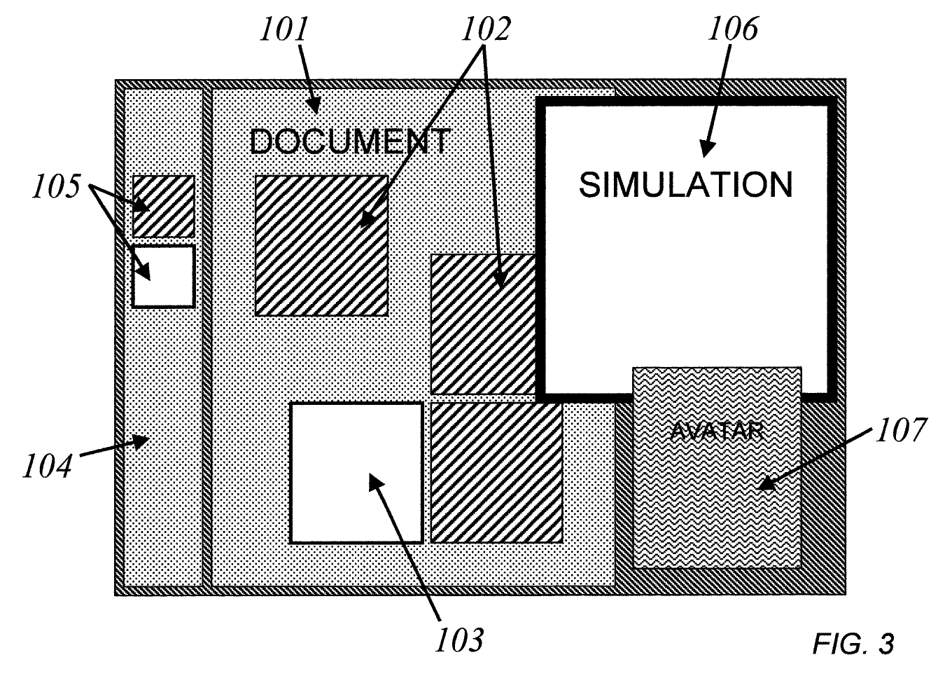

FIG. 3 shows a diagram of the screen layout when ExpertShopper™ Alpha is running. The monitor has four windows open: the main browser window (101); the thumbnails window (104), which shows small images of the products identified for simulation; the simulation window itself (106); and a window for the avatar (107). The browser window (101) may contain one or more graphic images (102), one of which (103) has been selected for display in the simulation window (106).

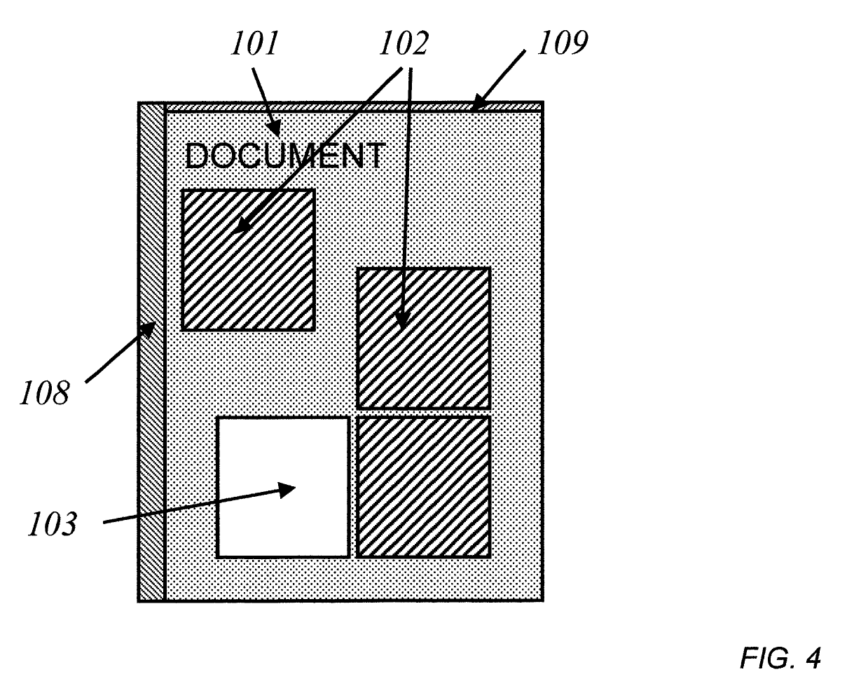

FIG. 4 shows a diagram of the main browser window (101). The window displays the downloaded document in the main frame, but it also contains a toolbar frame (108) and an indicator frame (109). The toolbar frame (108) is the logical location of the engine that carries out the examination of the main content frame. Because the frame extensively uses script to access the document, it is necessary to overcome the internal browser security, and this is normally done by granting permission in response to a browser request. The scripts in the toolbar frame (108) examine every graphic in the document; those that match any entry in a list of strings are reproduced as thumbnails in the thumbnail frame (104). By preference, when a match is made, the script automatically opens a new window (106) and loads the VRML plug-in, followed by the VRML file for the product simulation.

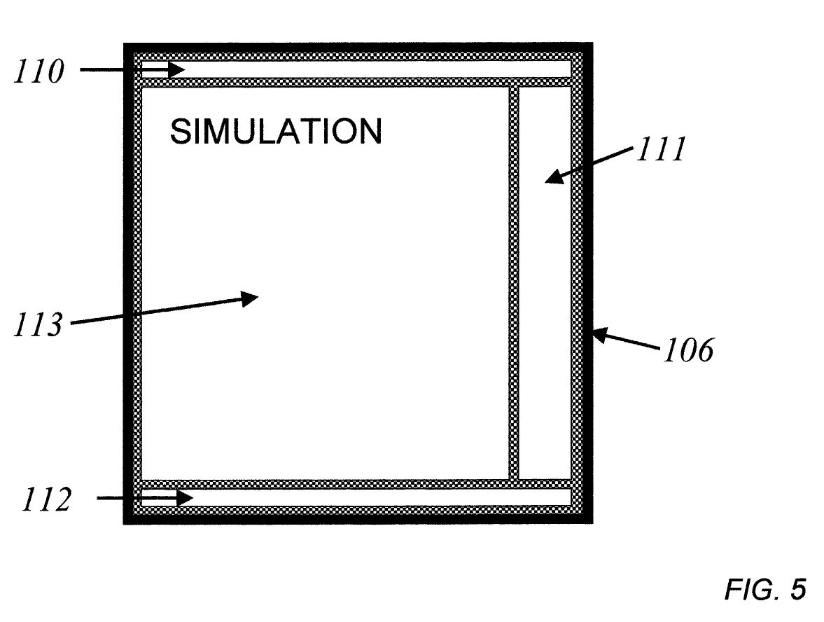

FIG. 5 shows a diagram of the simulation window (106). It is divided into four regions: (1) a message bar (110) on which appear various messages to the user; (2) an action bar (111) which contains various tools, such as buttons, for interacting with the VRML simulation; (3) an options bar (112) containing buttons for utility functions that affect the entire window; and (4) the main simulation itself (113) containing the product VRML simulation inside the VRML plug-in in the browser.

It will be appreciated that although the version of the software just described has been implemented, it does not define or circumscribe this invention. Rather, it should be considered exemplary of various realizations that are within the scope of the invention, as set forth in the Claims.

### Exploiting the Present Invention

Appropriate uses of the present invention are easy to imagine by analogy to a live shopping experience. However, the electronic nature of the simulation provides vastly greater range of options. The following list indicates some of the ways in which the present invention can be used advantageously.

Defining a new product using existing components

Showing what the product does or how it works

Putting the product into context of typical use

Putting the product into a typical environment

Providing a “test drive” in context of typical use or environment

Generating performance indicators for comparison shopping

Simplifying and explaining very complicated behavior

Showing assembly, disassembly, storage, maintenance, disposal

Selling services by showing them in use

Predicting behavior in unusual environments

Predicting behavior in combination with other products

Personalizing and customizing the product before ordering

Providing side-by-side comparison of different products

Providing entertainment leading to purchase

Providing warnings, conditions, waivers, and use

Simulating product, aging, damage, repair, abnormal behavior

Diagnosing abnormal behavior

Providing interactive customer support.

### Appropriate Subjects

The intrinsic nature of the simulation process both enables and limits the kinds of products that are most appropriate for simulation with this invention. In this section we list a few guidelines. These help to define the scope and nature of this invention.

Products constructed with hierarchical levels of similar parts

These systems tend to be built by assembling standardized parts into unique configurations. Examples include:

Audio

Avatars

Books

Clothing

Cosmetics

Data representation

Design services

Electronics (including cameras, calculators, personal assistants, etc.)

Food preparation

Industrial equipment (including medical, power tools)

Novelty items

Special services

Sports equipment

Travel destinations.

Products that need to be put into context

Certain products could benefit from simulating the environment in which it is found or used, or other systems with which the product interacts. Examples include:

Body improvement

Convective heating and cooling, fans, etc.

Sensors, actuators.

Continuous systems

Models of continuous system normally require real-time solutions of equations or sets of equations. Examples of these systems are:

Gases

Liquids

Sound

Weather.

Hybrid 2D and 3D systems

While the emphasis in this description is on 3D simulations of physical objects, the addition of 2D images to such simulations can be advantageous, particularly for products that contain considerable unique artwork. Examples include:

Automobiles

Avatar

Faces

Landscapes.

Avatars

The system allows the introduction of avatars (images of persons or other agents). The avatars can act as “experts,” implementing an expert system of knowledge to interact with the product and with the user. The “experts” seek to convey to the user that he, too, can become an “expert” by using this system. The avatars are implemented using the same technology used for simulating the products. In this context, the experts are products, and present the same requirements for assembly and operation.

### Less Appropriate Subjects

In principle, the present invention applies to any system for which a simulation can be developed. However, the greatest advantages (e.g., zero bandwidth) is realized if the product is assembled from generic parts that can be used (presumably with specific configuration) for many different products. In this section we give examples of system for which the present invention is less appropriate.

Systems that involve a large number of degrees of freedom

These systems require keeping track of many parameters, presenting an overwhelming challenge for computing. Typical such systems are:

Explosions

Splashes

Liquid bodies

Fur, hair, and other 3D textures.

However, to the extent that these systems can be represented by simpler models, they are good candidates. Examples include flames and convective heating.

Systems with considerable unique geometry, artwork, or unique uses

These systems will require considerable product-specific data to generate acceptable graphic rendering, and the low bandwidth advantage of the present invention will be correspondingly smaller. Also, these systems tend to have small populations: there are not many products in a category that could be assembled with the same components. Examples include:

Artwork

Automobiles

Financial transactions

Furniture

Jewelry

Real human faces

Small utility items

Sounds (unique)

Toys with high design content

Unique items.

Systems that are very simple

Systems for which there is very little action are appropriate for the present invention. However, the full power and advantage of the invention is not fully realized unless complex behavior is part of the product. Systems with little intrinsic behavior include:

Cleaning supplies

Food

Household

Magazines

Office supplies

Paper.

Simulations that involve simple linear and triggered motion

These actions often can be done with tools embedded in commercial APIs. Examples are:

Moving at constant speed

Rotating at constant speed

Opening and closing doors.

### The Databases in the Manager and Client

Both the Manager and the Client maintain databases of several kinds, and there is some overlap between their content. Generally, the Manager will provide updates to the Client database on demand, or on criteria. Recovery from complete failure of the Client machine is possible using backup files stored on the Manager.

The core data in the databases is (“ProductLocation”,“ProductName”) pairs. “ProductLocation” is the URL where the product is located on the network. “ProductName” is the unique name or identifier of the product.

The Manager database actually will be more complicated and more complete than the simple binomial form shown above. Generally it will be an efficient relational database, allowing search along many path and expansion as the content grows. It is likely that this database will always provide for a unique identifier, manufacturer, model, seller, related URLs, and comments.

### Identifiers

One way to ensure high performance is to restrict the identifiers to be the URLs of the documents, rather than URLs of elements embedded in those documents. This is appropriate if the document is completely devoted to a single product, so there is a one-to-one correspondence between the document URL and the product.

Another effective method to ensure high performance is to restrict the identifiers to graphic elements embedded in the document. The following list shows a typical set of URLs embedded in a typical HTML document.

http://www.host.com

http://www.host.com/Index/IndexHeader.gif

http://www.host.com/Index/WelcomeText.gif

http://www.host.com/ProductA.gif

http://www.host.com/ProductB.gif

http://www.host.com/ProductC.gif

http://www.host.com/Buttons/ShowButton.jpg

http://www.host.com/Buttons/PurchaseButton.jpg

http://www.host.com/Buttons/SupportButton.jpg

The first URL is that of the document itself, while the following URLs refer to graphics embedded in that document. The graphic URLs arrive with the HTML text, and are immediately accessible through the browser API, long before the browser has actually downloaded the graphics. Suppose that the Client reference list includes the identifier “ProductB.gif.” The Client searches the URL list, and finds a match in the URL http://www.host.com/ProductB.gif.

The actual HTML document is the target of the matching search. The following fragment shows the beginning of a typical HTML document:

<!DOCTYPE HTML PUBLIC “-//W3C//DTD HTML 3.2 Final//EN”><HTML>
<HEAD><TITLE>Welcome to Host</TITLE><META NAME=“generator”
CONTENT=“BBEdit 4.5”></HEAD><BODY BGCOLOR=“#FFFFFF”><TABLE
BORDER=“0”ELLSPACING=“0”CELLPADDING=“0”WIDTH=“600”><TR>
<TD WIDTH=“600”ALIGN=CENTER><IMG SRC=“Index/IndexHeader.gif”
ALT=“index header”WIDTH=“600”HEIGHT=“80”ALIGN“left”></TD></TR>
</TABLE><TABLE CELLSPACING=“0”CELLPADDING=“0”WIDTH=“602”>
<TR><TD WIDTH=“167”VALIGN=TOP><TABLE CELLSPACING=“5”
CELLPADDING=“0”><TR><TD WIDTH=“150”HEIGHT=“240”
VALIGN=TOP><IMG SRC=“Index/WelcomeText.gif”WIDTH=“150”
HEIGHT=“212”BORDER=0 ALT=“Welcome”></TD></TR></TABLE></TD>
<TD WIDTH=“480”VALIGN=TOP><A REF=“SellPages/ProductA.html”><IMG
SRC“ProductA.gif”WIDTH=“319”HEIGHT=“240”BORDER=0></A><IMG
SRC=“Index/ProductAText.gif”WIDTH=“120”HEIGHT=“240”BORDER=0
ALT=“Welcome”></TD></TR><TR><TD ALIGN=CENTER VALIGN=TOP>
<TABLE CELLSPACING=“5”CELLPADDING=“0”><TR><TD WIDTH=“150”
VALIGN=TOP><A HREF=“SellPages/ProductB.html”><IMG
SRC=“Buttons/ProductB.jpg”WIDTH=“148”HEIGHT=“20”BORDER=0
ALT=“Scanners and Sensors”></A></TD></TR><TR><TD VALIGN=TOP><A
HREF=“SellPages/ProductC.html”><IMG SRC=“Buttons/ProductC.jpg”
WIDTH=“148”HEIGHT=“20”BORDER=0 ALT=“Levels”></A></TD></TR>
<TR><TD VALIGN=TOP><A HREF=“SellPages/Show.html”><IMG
SRC=“Buttons/ShowButton.jpg”WIDTH=“148”HEIGHT=“20”BORDER=0
ALT=“Measuring Tools”></A></TD></TR><TR><TD VALIGN=TOP>

In this document, the following strings are sufficiently specific that they could serve as identifiers:

Welcome to Host

Index/IndexHeader.gif

Index/WelcomeText.gif

SellPages/ProductA.html

ProductA.gif

Index/ProductAText.gif

SellPages/ProductB.html

Buttons/ProductB.jpg

SellPages/ProductC.html

Buttons/ProductC.jpg

SellPages/Show.html

Buttons/ShowButton.jpg

Purchase.html

Buttons/PurchaseButton.jpg

SellPages/Support.html

Buttons/SupportButton.jpg

This list illustrates the necessity for the identifier to uniquely determine the product. For instance, suppose the Client included in its reference list the identifier “ProductB.jpg”. It may happen that different documents on completely unrelated servers both include a graphic file referred to as ProductB.jpg, thus:

http://www.host_one.com/dirA/dirB/dirC/ProductB.jpg

http://www.host_two.com/dirD/dirE/dirF/ProductB.jpg

If the Client were to search either of these documents using the target ProductB.jpg, it would record a match. However, the Client would then be unable to determine uniquely which product this match refers to. The obvious solution is to use the following binomials as identifiers:

(host_one,ProductB.jpg)→“host_one_ProductB”

(host_two,ProductB.jpg)→“host_two_ProductB”

The association of the product with a set of components and assembly instructions is made through a relational database. The following tables show how this can be done.

| ProductID | ComponentList | InstructionList |
|---|---|---|
| “ProductA“ | ComponentListA | InstructionListA |
| “ProductB“ | ComponentListB | InstructionListB |
| “ProductC“ | ComponentListC | InstructionListC |
| “ProductD“ | ComponentListD | InstructionListD |
| “ProductE“ | ComponentListE | InstructionListE |

| ComponentList | Components |
|---|---|
| ComponentListA | CA101, CA102, CA103, CA104, CA105, CA106, |
| | CA107, CA108, CA109, CA110, CA111, CA112 |
| ComponentListB | CB101, CB102, CB103, CB104, CB105, CB106, |
| | CB107, CB108, CB109, CB110, CB111, CB112, |
| | CB113, CB114, CB115, CB116 |
| ComponentListC | CC101, CC102, CC103 |
| ComponentListD | CD101, CD102, CD103, CD104, CD105, CD106 |
| ComponentListE | CE101, CE102, CE103, CE104, CE105, CE106, |
| | CE107, CE108, CE109, CE110, CE111, CE112 |

| InstructionList | Instructions |
|---|---|
| InstructionListA | IA101, IA102 |
| InstructionListB | IB101, IB102, IB103, IB104, IB105, IB106 |
| InstructionListC | IC101, IC102, IC103 |
| InstructionListD | ID101 |
| InstructionListE | IE101, IE102, IE103, IE104, IE105 |

These tables associate a unique product identifier with lists of components and instructions for assembling the components into complete simulations of the products.

The importance of using generic components and instructions is easy to see by reference to these tables. For instance, suppose the following equivalences could be used:

| Entity | Generic | Parameters |
|---|---|---|
| CB108 | GC108 | P1, P2, P3 |
| CD114 | GC108 | P1, P2, P3 |
| CE103 | GC108 | P1, P2, P3 |
| IA102 | GI102 | P1, P2, P3, P4, P5 |
| IC117 | GI102 | P1, P2, P3, P4, P5 |
| ID107 | GI102 | P1, P2, P3, P4, P5 |

Then this enables storage on the Client of generic components GCx and generic instructions GIx, using the parameters Py to configure the generic entities for the specific cases.

### Components

Basic Paradigm

This invention operates on the paradigm of “assemble-from-components.” The request for simulating an object or system generates a series of actions analogous to acquiring the components, and instructions for their assembly. The components are in some cases the equivalents of physical parts: buttons, lights, hinges, screws, etc. In other cases the components are simply code fragments: pieces of virtual worlds that can be assembled into objects or systems. For instance, the ability of all wheels to rotate around an axis is a component of behaviors found in many systems, and is a generic component in the library.

The dynamic behavior of the object or system is generated by varying parameters defining the components. The simplest behaviors are movements: changes of position. More complicated behaviors may combine movement with rotation, size and shape change, and color, texture, or reflective changes.

Dynamics need not be visible as a graphic effect. For instance, alteration of the temperature of a body may cause effects other than movement. For simulations of time-dependent entities such as audio or video tracks, changes in the details of the clips, their timing, and their relative strengths will alter the audio/visual simulation.

Even more abstract is the alteration of mathematical, numeric, symbolic, or logical systems. For instance, suppose the system is a set of equations describing the behavior of a dynamic system. Alteration of the equations themselves is a kind of dynamics.

Number of components

Using generic components and instructions will be essential if the system and method of this invention is able to grow larger than a small number of simulations. The reason is that the storage capacity of the Client is limited, most probably by preference.

Suppose that 1 MB of disk storage is allocated for components. Then one could use this to store 1 complete product simulation of 1 MB. Alternatively, one could store 10 components of 100 kB each, and use them to assemble many different products. A reasonable estimate of this would be the number of ways these components could be arranged in pairs, triples, etc. For N components, this is given by SUM(n=1,N)[N!/(N−n)!(n!)]=0.10^{3N/10} (approximately). The following table shows the number of possible products for various numbers of components, and also an estimate of the actual number of products in the world that could be reasonably considered to be assembled from these numbers of components.

| Number of | Number of | Est. Number |
|---|---|---|
| components | possible products | actual products |
| 1 | 1 | 10,000,000 |
| 5 | 31 | 1,000,000 |
| 10 | 1,023 | 500,000 |
| 20 | 1,048,575 | 100,000 |
| 30 | 1,073,741,823 | 50,000 |
| 100 | 1.0E+30 | 10,000 |
| 1,000 | 1.0E+300 | 5,000 |
| 10,000 | 1.0E+3,000 | 1,000 |

This table explains why we have the general impression that the number of possible products is infinite: with only 20 components, more than a million products are possible. With 30 components, more than a billion products are possible. And with 100 components, it is the astronomical number 1.0E+30.

It is significant that about 15 components is sufficient to make 300,000 products, and this is a not unreasonable estimate of the number of such products in the world. Thus, we infer that products with fewer than 15 components will require components that are different for different products; that is, the same set of 15 components that will not suffice to build products with the observed variation. In contrast, for products with more than 15 components, the potential number of products vastly exceeds the actual number, from which we infer that not many more than 15 components will be necessary to assemble any product in the world. It is therefore reasonable that a useful component library might have roughly 100 components; 10 is too few, and 1000 is more than needed.

With a storage space of 10 MB, each of 100 components could occupy 100 kB, which is a reasonable size for a parametrized component with sufficient variability to conform to a specific product.

Form of the components

In the simplest concept, a component is an object that can be displayed. A product simulation composed of such components would begin with a source artwork file. This can be written using any of numerous content-generating languages and applications. For instance, the Virtual Reality Modeling Language (VRML) is particularly adept at representing 3D scenes constructed from simple geometric parts.

The build-up of components from smaller components is a central requirement of this invention. The following schemes show one procedure for doing this by building up VRML objects:

C1={Object,Script(s),Sensor(s),ROUTE(S)}

C2=Group{Object1,Object2,C1},Script(s),Sensor(s),ROUTE(S)}

C3{Object1,C2,C3},Script(s),Sensor(s),ROUTE(S)}

C4{Object1,Object2,Object3,C2,C3},Script(s),Sensor(s),ROUTE(S)}

C5{Object1,Object3,C2,C4{,Script(s),Sensor(s),ROUTE(S)}

A more versatile form of graphic components would be VRML code fragments. Whether the fragment alone would produce a renderable graphic image in a browser is not important; what is important is that the pattern of the fragment can be used for many such products. The following table shows an example of a code fragment that is encountered repeatedly. This fragment of text can be considered a component; when assembled with other similar fragments, together they will produce a complete product simulation.

| Pseudo code | VRML code |
|---|---|
| Group { | DEF <systemName> Transform { |

| Object_1 | DEF <objectName_1> Transform { | |
|---|---|---|
| Object_2 | [<field> | <initialValue>] |
| } | children | [ ] |
| Script | } | |
| Sensor | DEF <objectName_2> Transform { | |
| ROUTES | [<field> | <initialValue>] |
| | children | [ ] |
| | } | |
| | } | |

| DEF <scriptName> Script { | | | |
|---|---|---|---|
| url | [ ] | | |
| mustEvaluate | FALSE | | |
| directOutput | FALSE | | |
| [eventIn | <eventTypeName> | <eventInName>] | |
| [field | <fieldTypeName> | <fieldName> | <initialValue>] |
| [eventOut | <eventTypeName> | <eventOutName>] | |
| } | | | |

DEF <sensorName> <sensorType> { <body> }
[ROUTE scriptName.<fieldName>_changed TO <field>.set_<fieldName>]
[ROUTE scriptName.<eventName> TO systemName.set_<systemField>]

Object-oriented components

The availability of C++, Java, and other object-oriented programming languages introduces the opportunity to develop object-oriented components. These languages are built on the paradigm of physical analogies, hence the use of such languages is more than opportune; it is raisin d'etre. As an example, a Java class could be created that contains a parametrized description of a generic key (=a functional button). This code fragment would accept as input a set of parameters, and would give as output the code required by the assembly instructions for the simulation. In this sense, the process of componentization of the world would be one of generating classes of software objects that are optimized for assembling into simulations of commercially important products. It is this combination that distinguishes the components in this invention from other component schemes.

Example of a generic compound component

Many products have assemblies that are so similar they can be derived from a common generic ancestor. A good example is the key and the 9-keypad found on all electronic calculators.

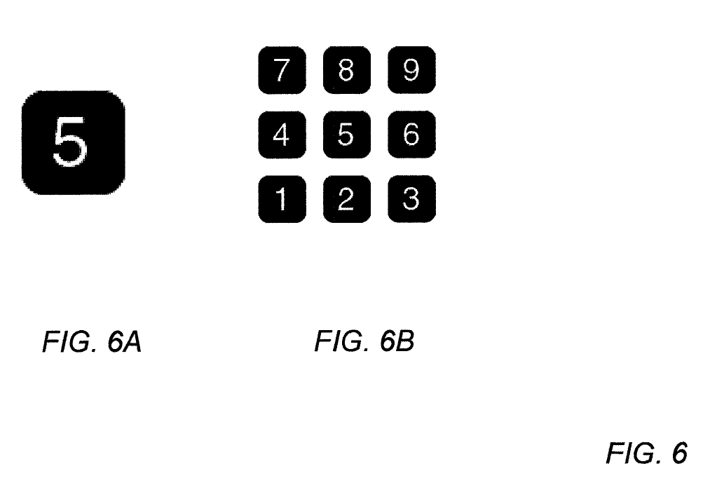

FIG. 6A shows a diagram of a generic key, and FIG. 6B shows a generic 9-key keypad assembled from such keys in the world-standard format.

The fact that this keypad is always found with exactly the same key sequence suggests that it is unnecessary to specify the positions of all nine keys. Instead, we could provide the description for a single key and the simple instruction that we want a standard 9-key keypad using the sample key as the template.

But even the description of the key is highly redundant. For instance, the key is square, with identical rounded corners. The label is sans serif, centered, ½ the height of the keywidth, etc. Even the functioning of the key is not unique: it is a switch, or a trigger. It has a built-in light that toggles on and off. These examples indicate that there are many aspects of a key that are redundant, and can therefore be derived from generic components.

Roughly 14 variable values are sufficient to completely specify this keypad, so long as the simulator contains the generic key and keypad models.

| KEY | Shape | SQUARE |
|---|---|---|
| | Side | 1.0 |
| | Height | .3 |
| | CornerRound | ..2 |
| | Color | COLOR_RED |
| | Light | FALSE |
| | Label | TRUE |
| | Operation | TOGGLE |
| LABEL | Character(s) | 5 |
| | Fontstyle | SANS |
| | Size | .5 |
| | Color | WHITE |
| KEYPAD | Style | 1 |
| | Key spacing | .2 |

The following description applies to the 9-key keypads on both products: “Rectangular, black, with rounded comers and slightly raised crown, with label of white sans-serif numeral centered.” Whenever the verbal description of assemblies comprising a product are the same, a generic component can be used in the simulation, resulting in increased efficiency and reduced network bandwidth demand.

Examples of component systems

The following table shows a simple example of the reuse of generic components. Six common products were selected, and a reasonable analysis of the components was made. It is interesting to compare this set with the numerical analysis on components given above. For these products, 23 components were required to make 6 products. This is consistent with the conclusion that more than 15, but fewer than 100, components are necessary to build products that are sensibly different. The implication is that to simulate all electronic products we will need perhaps 100 components, but not 10 and not 1000 components.

| | camera | lamp | fan | phone | radio | cellphone |
|---|---|---|---|---|---|---|
| base | | * | | | | |
| blades | | | * | | | |
| body | * | | | | | * |
| bulb | | * | | | | |
| cable | | | | | * | |
| case | * | | | | | * |
| connector | | | | | * | * |
| cord | | * | * | | * | * |
| cowling | | | | * | * | * |
| digital display | | | | * | * | * |
| feet | | | | | * | |
| frame | | * | * | | | |
| keypad | | | | * | | * |
| knobs | | | | | * | * |
| lens | * | | | | | |
| light | | | | | | * |
| microphone | | | | * | | * |
| motor | | | * | | | |
| post | | * | | | | |
| shade | | * | | | | |
| socket | | * | | | | * |
| speaker | | | | * | * | * |
| strap | * | | | | | * |

Case study: Cell Phone

As an example of the analysis required in the Generator, we exhibit here the analysis for simulation of a cell phone. The following table presents estimates of the number of bytes necessary to specify the various (simplified) structural and behavioral components.

CELLPHONE

| | # | # | # | # | # |
|---|---|---|---|---|---|
| | instances | symbols | booleans | numbers | bytes |
| {component_list} | 1 | | | | 0 |
| {display_elements} | 2 | | | | 0 |
| acoustic_response | 1 | | | | 0 |
| action | 8 | 2 | | 10 | 96 |
| angle | 1 | | 1 | 1 | 2 |
| attachment | 3 | | | 3 | 9 |
| brightness | 1 | | | 1 | 1 |
| capacity | 7 | | | 1 | 7 |
| closure | 3 | | 1 | 3 | 12 |
| coil | 1 | | | 6 | 6 |
| color | 30 | | | 3 | 90 |
| connectors | 1 | 2 | 1 | 3 | 6 |
| contacts | 1 | 2 | 1 | 3 | 6 |
| dimensions | 30 | | | 3 | 90 |
| display | 1 | 10 | 10 | 20 | 40 |
| driver | 1 | | 1 | 12 | 13 |
| electrical_output | 1 | | | 1 | 1 |
| function | 2 | 2 | 1 | 10 | 26 |
| heat_generation | 3 | | | 1 | 3 |
| input | 1 | | | 3 | 3 |
| intensity | 1 | | | 1 | 1 |
| leads | 1 | | | 5 | 5 |
| lighting | 1 | | | 3 | 3 |
| location | 30 | | | 3 | 90 |
| magnet | 1 | | | 2 | 2 |
| material | 30 | 2 | | 3 | 150 |
| motion | 2 | | | 1 | 2 |
| mount | 1 | | | 5 | 5 |
| orientation | 30 | | | 3 | 90 |
| output | 1 | | | 1 | 1 |
| power | 2 | | | 1 | 2 |
| power_curve | 1 | | | 12 | 12 |
| power_requirement | 2 | | | 1 | 2 |
| restraints | 2 | | 5 | 5 | 20 |
| sensitivity | 1 | | | 1 | 1 |
| shape | 30 | | | 12 | 360 |
| sound | 1 | | 5 | 10 | 15 |
| type | 1 | 1 | | | 1 |
| wire_size | 1 | | | 1 | 1 |
| | 238 | 21 | 26 | 154 | 1174 |

Nongraphic components

Elsewhere it has been indicated that components do not need to represent physical objects that can be rendered on a computer screen. In fact it is possible to define objects and systems that have the following non-graphic character, and these are good candidates for componentization. It is a central purpose of this invention to include these nongraphic components.

AUDIO

VIDEO

TACTILE

OLFACTORY

MATHEMATICAL

LOGICAL

BEHAVIORAL.

Behaviors as components

The last item in the list above is “behaviors,” by which is meant the change in value of certain variables. In this section we list some generic behaviors that would be developed as part of a comprehensive simulation engine. The meanings of “Part,” “Component,” and “Product” are given elsewhere in this document.

| Behavior | Part | Component | Product |
|---|---|---|---|
| Abrasion | | * | |
| Aging | * | * | * |
| Air resistance | | * | * |
| Animation | | * | * |
| Appearance alteration | * | * | * |
| Bell ringing | | * | * |
| Bending | * | * | * |
| Blowing | | * | |
| Boiling | * | * | |
| Breaking | * | * | * |
| Burning | * | * | * |
| Chemical change | * | | |
| Clamping | | * | |
| Closing | * | * | * |
| Compression | * | | |
| Contracting | * | | |
| Convecting | | * | |
| Cooking | | * | * |
| Cutting | | * | * |
| Damage/Abrasion | | * | |
| Damage/Distortion | | * | |
| Damage/Heat | | * | |
| Damage/Scratching | | * | |
| Damage/Water | | * | |
| Damping | | * | |
| Diffusing | | * | |
| Dissolving | * | | |
| Distorting | * | * | * |
| Ducting | | * | |
| Dumping | | * | |
| Echoing | | * | |
| Environmental/Air resistance | | * | |
| Environmental/Convection | | * | |
| Environmental/Gravitational fall | | * | |
| Environmental/High pressure | | * | |
| Environmental/Underwater | | * | |
| Environmental/Vacuum | | * | |
| Environmental/Wind | | * | |
| Expanding | * | | |
| Exploding | * | * | |
| Extending | * | * | * |
| Falling | * | | |
| Fanning | | * | * |
| Flexing | * | * | |
| Floating | * | * | * |
| Flowing | * | * | |
| Flying | | * | * |
| Folding | * | * | * |
| Freezing | * | | |
| Gliding | | * | |
| Heat absorption | * | | |
| Heat generation | * | | |
| Heat reflection | * | | |
| Heated liquid | * | | |
| Heating | * | * | |
| Heating a space | | * | * |
| Hinge | | * | |
| Image alteration | | * | * |
| Impacting | | * | |
| Inflating | | * | |
| Inserting | * | * | |
| Kiting | | * | |
| Lifting | | * | |
| Light absorption | * | | |
| Light generation | * | | |
| Light reflection | * | | |
| Light refraction | * | | |
| Lighting | | * | |
| Liquid flow | * | | |
| Luminescing | * | | |
| Melting | * | | |
| Opening | * | * | |
| Optics/Illumination | | * | * |
| Optics/Ray tracing | | * | * |
| Oscillating | * | * | |
| Pouring | | * | |
| Pouring from container | | * | * |
| Pouring liquid | * | | |
| Propagating | | * | |
| Pumping | | * | * |
| Radio reception | | * | * |
| Radio waves | * | | |
| Restraining | * | * | |
| Retracting | * | * | |
| Reverberating | | * | |
| Rotating | * | * | |
| Scratching | | * | |
| Sensing | | * | * |
| Shadowing | * | * | |
| Shaving | | * | * |
| Slicing | | * | * |
| Soaring | | * | * |
| Sound absorption | * | | |
| Sound generation | * | | * |
| Sound reflection | * | | |
| Spinning | | * | |
| Stacking | | * | |
| State changing | * | | |
| Stepping | | * | |
| Stepwise displacement | * | * | |
| Stepwise rotation | * | * | |
| Stirring | | * | |
| Storing | | * | |
| Structural element | * | * | * |
| Sucking | | * | |
| Switch off | * | * | |
| Switch on | * | * | |
| Switch toggle | * | * | |
| Thermal expansion | * | | |
| Torsion | | * | |
| Ultrasonics | | * | |
| Unrolling | | * | |
| Vibrating | * | * | |

### Concluding Remarks

This disclosure has described a method and system for distributing simulations of objects and systems in a network environment that requires effectively zero additional bandwidth and zero modification to the Server. By way of discussion and illustration with examples, various realizations of this invention have been described, including one embodiment that is fully functional and in commerce.

Because the nature of this invention is considerably more general than any of these examples or embodiments, or all of them taken together, this disclosure should not be interpreted as limiting the scope of the invention. Rather, the full implication of the invention, as expressed in the Claims, should be appreciated.

Because this invention involves both a method and a system, it may be considered to be either, or both. Therefore, it should not be compromised by virtue of being interpreted from one viewpoint or the other.

It will also be appreciated that a person skilled in the art and science of network communication, computer science, and 3D virtual-reality graphics will be able to perceive and implement many changes and modifications to this disclosure that nevertheless do not depart from the spirit or scope of the invention.

What is claimed is:

1. A method for distributing simulations of objects and systems on a computer network, wherein:
the simulation comprises a set of components and instructions for assembly of those components;
a document containing information about the object or system is obtained from a network computer;
the information in the document is compared to reference information to uniquely identify the object or system;
the simulation is assembled from the components according to the instructions.

2. The method described in claim 1, wherein the network is the internet and the method of distribution of documents is by the http-protocol as used on the world-wide-web (WWW).

3. The method described in claim 1 wherein the information for identifying the object or system is in the form of a bitstream.

4. The method described in claim 1 wherein the information for identifying the object or system is in the form of bitmaps.

5. The method described in claim 1 wherein the information for identifying the object or system is in the form of sequences of ASCII characters.

6. The method of claim 1, wherein the simulation is at least partially of the form of a graphic representation of an object or system, suitable for display on a computer monitor, in which case the components are graphic elements that can be combined according to the instructions to form a complete graphic image.

7. The method of claim 1, wherein the simulation is at least partially of the form of an audio track, suitable for playing through a computer audio system.

8. The method of claim 1, wherein the simulation is at least partially of the form of a video track, suitable for playing through a computer video system.

9. The method of claim 1 wherein the simulation is at least partially of the form of a tactile pattern, suitable to be experienced using a transducer external to, but driven by, a computer.

10. The method of claim 1, wherein the simulation is at least partially of the form of an olfactory pattern, suitable to be experienced using a transducer external to, but driven by, a computer.

11. The method of claim 1, wherein the simulation is at least partially of the form of a mathematical or symbolic algorithm, model, or dataset, suitable for use only by other software within a computer.

12. The method of claim 1, wherein the simulation is at least partially of the form of a logical entity, suitable for use by software capable of exercising the logical system and producing results that can be interpreted and/or displayed.

13. The method of claim 1, wherein the “components” do not directly represent parts of the simulated object or system, but rather are procedures for generating such components, such as numeric or mathematical procedures realized by software.

14. The method of claim 1, wherein the “instructions” are not direct instructions for assembly the simulated object or system from components, but rather are procedures for generating such instructions, such as symbolic or logical algorithms realized by software.

15. The method of claim 1, wherein the simulation has the capability to include streaming components such as audio and video, said components not being stored on the client but being incorporated in the simulation “on-the-fly”.

16. The method of claim 1, wherein the simulation includes the capability to receive, interpret, and respond to sensory input, including but not limited to audio, video, tactile, olfactory, numerical, symbolic, or logical data, thereby providing functions for interaction with other devices, systems, and computers without a human operator.

17. The method of claim 6, wherein the simulation is at least partially of the form of a human-appearance avatar, said avatar having capability to interact with other parts of the simulation, thereby providing the appearance and function of a human partner.

18. A system and method for distributing simulated objects and systems on a computer network wherein:
A “generator” creates a simulation consisting of components and instructions for assembling those components into a complete simulation;
A “manager” stores, manages, and distributes simulations, and identifiers corresponding to those simulations;
One or more “servers” store and transfer documents;
One or more “clients” receive, store, and manage components, instructions, and identifiers; receive documents from servers and find identifiers corresponding to simulations; and generate the simulations from the components and instructions.

19. The system and method of claim 18, wherein the “generator” comprises:
Means for creating a original computer simulations of physical objects or systems;
Means for dis-assembling the simulation into components;
Means for generating instructions for re-assembling the components to form the original simulation.

20. The system and method of claim 18, wherein the “manager” comprises means for receiving, storing, managing, and distributing the following:
Components that can be assembled to form a simulation;
Instructions for assembling components into a simulation;
Identifiers that uniquely determine a set of components and instructions;

21. The system and method of claim 18, wherein the “server” consists of one or a multiplicity of computers that are connected in a network such as the internet, to which the client and manager computers are also connected, and which have the means to store and download documents requested by clients using document-transfer protocols such as ftp and http.

22. The system and method of claim 18, wherein the “client” consists of one or a multiplicity of computers that are connected in a network such as the internet, to which the server and manager computers are also connected, and which have the following:
Means to download and store documents requested from the server using document-transfer protocols such as ftp and http;
Means to examine the downloaded documents and compare their contents with a previously stored reference list of identifiers providing unique association with a pre-defined set of components and assembly instructions;
Means to use the assembly instructions to assemble the components into the full simulation;
Means to present the simulation as a graphic representation on a computer display.

23. A system for distributing simulated objects and systems on a computer network comprising:
A “generator” having the means to create a computer simulation of an object or system, and to separate that simulation into “components” and “instructions” for assembling those components into the simulation,
A “manager” having the means to receive, store, manage, and distribute the simulations provided by the generator; also the means to acquire, create, store, manage, and distribute “identifiers” uniquely associated with particular simulations;
One or more “servers” having the means to store and deliver documents that may contain said identifiers over a network connection;
One or more “clients” having the means to receive, store, and manage components, instructions, and identifiers from the manager; also the means to receive and display documents from the servers; also the means to examine the received documents to locate valid identifiers of specific simulations; and also the means generate the simulations from the components and instructions for display on the client computer.

24. The system of claim 23, wherein the “generator”, “manager”, “client” and “server” are separate computers connected in a network.

25. The system of claim 23, wherein any or all of the “generator”, “manager”, and “server” are on the same computer, but in which the client is on a separate computer accessed only across the network.

26. The system of claim 23, wherein the “generator” makes use of dedicated hardware to generate and process simulations, in particular by capturing images of real products and converting them to digital form.

27. The system of claim 23, wherein the “client” makes use of dedicated circuits to increase performance, in particular for generating and displaying graphic images of high complexity.

28. A method of distributing simulated objects and systems on a computer network comprising two steps, wherein:
In the first step, the system is prepared according to the following actions:
A “simulation” is generated in the form of a set of “components” and “instructions”, such that the instructions can be used to assemble the components into a simulated object or system;
The instructions are placed on a “manager” computer and the components are placed on a client computer, the manager and client being connected only through a communications link such as a network;
A set of “identifiers” is generated that correspond to unique simulations (=sets of components and instructions), and the identifiers are placed on the “client” computer;
And wherein in the second step, the system is used according to the following actions:
The client requests a document from a “server” computer across the communications link, and the server responds by sending the requested document to the client;
The client searches the document for content that matches one or more previously stored identifiers, and if a match is found, uniquely identifies the corresponding simulation;
The client uses the identified instructions to assemble the identified components into the identified simulation.

29. The system of claim 28, wherein the simulation “components” and/or “instructions” are algorithms for generating actual components and/or instructions, which in turn are used to assemble the simulation.

30. The system of claim 28, wherein the “identifiers” are algorithms for generating actual identifiers in the reference information to be matched with information in the downloaded document.

31. The system of claim 28, wherein the “identifiers” comprise a body of information that can be used by an intelligent agent to make a “best-guess” identification of the object or system.

32. The system of claim 28, wherein the simulations are first placed on the “manager” computer, which in turn places them on the “client” computers.

33. The system of claim 28, wherein the requested document is altered to enhance its transfer to the client or the ability of the client to search it for identifying information.

34. The system of claim 28, wherein the downloaded document is searched on-the-fly as it arrives at the client, and the assembly of identified simulations is begun before the download of the document is complete.

35. The system of claim 28, wherein the “client” contain algorithms for automatically updating itself by dialog with the “manager,” such dialog including the replacement of components and/or instructions.

36. The system of claim 28, wherein the “manager” automatically generates derivative information about the use of the system, and provides the ability for multiple users to access that information by direct query.
